(19) United States
(12) Patent Application Publication
(10) Pub. No.: US 2026/0099843 A1
(43) Pub. Date: Apr. 9, 2026

(54) SYSTEMS AND METHODS FOR PREVENTING CHECK FRAUD

(71) Applicant: JPMORGAN CHASE BANK, N.A., New York, NY (US)

(72) Inventors: Balaguru NAGARAJAN, Melissa, TX (US); Kumar Rao KRISHNAGI, Powell, OH (US); Sivakumar NAGARAJAN, Lewis Center, DE (US); Vijay Kumar PERLA, Westerville, OH (US); Anilkumar REDDY, Southlake, TX (US); Kayla MALONE, Columbus, OH (US); Ramesh R DANDELA, Frisco, TX (US)

(21) Appl. No.: 18/907,132

(22) Filed: Oct. 4, 2024

(51) Int. Cl. G06Q 20/40; G06Q 20/04; G06V 30/10; G06V 40/30

(52) U.S. Cl. CPC G06Q 20/4016; G06Q 20/042; G06V 30/10; G06V 40/33

(57) ABSTRACT

Systems and methods for preventing check fraud are disclosed. In one embodiment, a method may include: (1) receiving, by a computer program, an image of a check presented for deposit comprising a unique identifier that is provided on the check, wherein the unique identifier uniquely identifies the check; (2) validating, by the computer program, the unique identifier by accessing a unique identifier database comprising a plurality of valid unique identifiers; and (3) accepting, by the computer program, the image of the check for payment in response to the unique identifier being valid.

### BACKGROUND OF THE INVENTION

### 1. Field of the Invention

Embodiments are generally directed to systems and methods for preventing check fraud.

### 2. Description of the Related Art

Check fraud is becoming increasingly common and presents a substantial challenge for financial institutions worldwide. Existing methods and systems are insufficient in effectively preventing and detecting fraudulent activities associated with checks. Without mechanisms to validate signatures and implement unique identifiers for issued checks, unauthorized alterations and counterfeit check schemes continue to exploit vulnerabilities in the banking system.

### SUMMARY OF THE INVENTION

Systems and methods for preventing check fraud are disclosed. In one embodiment, a method may include: (1) receiving, by a computer program, an image of a check presented for deposit comprising a unique identifier that is provided on the check, wherein the unique identifier uniquely identifies the check; (2) validating, by the computer program, the unique identifier by accessing a unique identifier database comprising a plurality of valid unique identifiers; and (3) accepting, by the computer program, the image of the check for payment in response to the unique identifier being valid.

In one embodiment, the unique identifier may include a hash of one or more of an account number, a routing number, a check number, a customer name, and a customer address.

In one embodiment, the step of validating, by the computer program, the unique identifier by accessing unique identifier database may include: extracting, by the computer program and from the image of the check, the unique identifier, a check image account number, a check image routing number, a check image check number, a check image customer name, and a check image customer address; hashing, by the computer program, one or more of the check image account number, the check image routing number, the check image check number, the check image customer name, and the check image customer address; and identifying, by the computer program, the hash of the one or more of the check image account number, the check image routing number, the check image check number, the check image customer name, and the check image customer address in the unique identifier database.

In one embodiment, the unique identifier may include a random alphanumeric value, wherein the unique identifier is mapped to a check number, and wherein the step of validating, by the computer program, the unique identifier by accessing unique identifier database may include: extracting, by the computer program and from the image of the check, the unique identifier and a check image check number; and determining, by the computer program, that the unique identifier is mapped to the check image check number in the unique identifier database comprising a plurality of valid unique identifiers.

In one embodiment, the step of validating, by the computer program, the unique identifier by accessing the unique identifier database may include: extracting, by the computer program, a check image check number from and the unique identifier from the image of the check; and verifying, by the computer program, the check image check number and the unique identifier are mapped together in the unique identifier database.

In one embodiment, the image of the check may also include a customer signature, and further comprising: receiving, by the computer program, a dataset comprising a plurality of signature images for a customer; training, by the computer program, a customer signature machine learning model with the dataset; verifying, by the computer program and using the customer signature machine learning model, that the customer signature is valid; and accepting, by the computer program, the image of the check for payment in response to the customer signature being valid and the unique identifier being valid.

In one embodiment, the customer signature machine learning model may be trained using convolutional neural networks to automatically learn discriminative features from the plurality of signature images.

In one embodiment, the unique identifier may be embedded within a machine-readable code on the check.

In one embodiment, the unique identifier may be provided on both a front side and on a back side of the check.

According to another embodiment, a method may include: (1) maintaining, by a computer program, a unique identifier database comprising a plurality of check numbers, each of the plurality of check numbers mapped to a unique identifier that uniquely identifies a check; (2) receiving, by a computer program and from a financial institution computer program for a financial institution, a check number and a unique identifier for a check that is being presented for payment to the financial institution; (3) verifying, by the computer program, that the check number is mapped to the unique identifier in the unique identifier database; and (4) notifying, by the computer program, the financial institution computer program of the verification.

In one embodiment, the unique identifier may include a hash of one or more of an account number, a routing number, a check number, a customer name, and a customer address.

In one embodiment, the unique identifier may include a random alphanumeric value.

In one embodiment, the computer program maintains one or more unique identifier databases for a plurality of financial institutions.

In one embodiment, the step of maintaining, by the computer program, the unique identifier database may include: receiving, by the computer program, an order for a plurality of checks comprising a plurality of check numbers; generating, by the computer program, a unique identifier for each of the plurality of check numbers in the order; and mapping, by the computer program, the unique identifiers to the check numbers in the order and storing the mapping in the unique identifier database.

In one embodiment, the method may also include: causing, by the computer program, each of the plurality of checks in the order to be printed with the unique identifier mapped to the check.

According to another embodiment, a system may include: a financial institution computer program for a financial institution; and a third party computer program for a third party. The third party computer program maintains a unique identifier database comprising a plurality of check numbers, each of the plurality of check numbers mapped to a unique identifier that uniquely identifies a check; the financial institution computer program receives an image of a check presented for deposit comprising a unique identifier that is provided on the check, wherein the unique identifier uniquely identifies the check; the financial institution extracts, from the image of the check, a check number and the unique identifier; the financial institution computer program provides the unique identifier and the check number to the third party computer program; the third party computer program verifies that the check number is mapped to the unique identifier in the unique identifier database; and the third party computer program notifies the financial institution computer program of the verification.

In one embodiment, the unique identifier may include a hash of one or more of an account number, a routing number, a check number, a customer name, and a customer address.

In one embodiment, the unique identifier may include a random alphanumeric value, wherein the unique identifier may be mapped to the check number.

In one embodiment, the image of the check may also include a customer signature, wherein: the financial institution computer program receives a dataset comprising a plurality of signature images for a customer; the financial institution computer program trains a customer signature machine learning model with the dataset; the financial institution computer program verifies, using the customer signature machine learning model, that the customer signature is valid; and the financial institution computer program accepts the image of the check for payment in response to the customer signature being valid and the unique identifier being valid.

In one embodiment, the customer signature machine learning model may be trained using convolutional neural networks to automatically learn discriminative features from the plurality of signature images.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for preventing check fraud according to an embodiment;

FIG. 2 illustrates a method for preventing check fraud according to an embodiment;

FIG. 2 illustrates a method for providing checks with unique identifiers according to an embodiment;

FIG. 3 illustrates a method for preventing check fraud according to an embodiment;

FIG. 4 depicts an exemplary computing system for implementing aspects of the present disclosure.

### DETAILED DESCRIPTION OF PREFERRED EMBODIMENTS

Systems and methods for preventing check fraud are disclosed.

Embodiments may enhance check security by implementing robust signature validation and unique identifier generation during the check printing process. By leveraging artificial intelligence (AI) and/or machine learning (ML) algorithms for signature verification and embedding a secure, unique identifier for each check, embodiments may reduce the incidence of check fraud and bolster trust in financial transactions.

Embodiments may use machine learning models trained on extensive datasets of authorized signatures to verify the authenticity of signatures on checks in real-time. This may involve advanced feature extraction techniques, such as convolutional neural networks (CNNs), to automatically learn discriminative features from signature images, ensuring only valid signatures are accepted and minimizing the risk of fraudulent transactions.

Embodiments may use cryptographic algorithms to generate a unique identifier for each check during the printing phase. This identifier may be provided to a check, such as by printing the unique identifier on the check such that the unique identifier may be used for verification of authenticity. The unique identifier serves as a digital fingerprint, making it virtually impossible to counterfeit or alter checks without detection.

Embodiments may integrate the AI/ML model into the check processing system, allowing for seamless capture and verification of signature images from checks. This integration ensures minimal disruption to existing workflows while maintaining efficiency in check processing.

Embodiments may provide a feedback loop that may be used to monitor the performance of the AI/ML model for metrics such as false positives and false negatives. The accuracy of the AI/ML model may be improved through retraining with additional data or fine-tuning its parameters based on performance metrics.

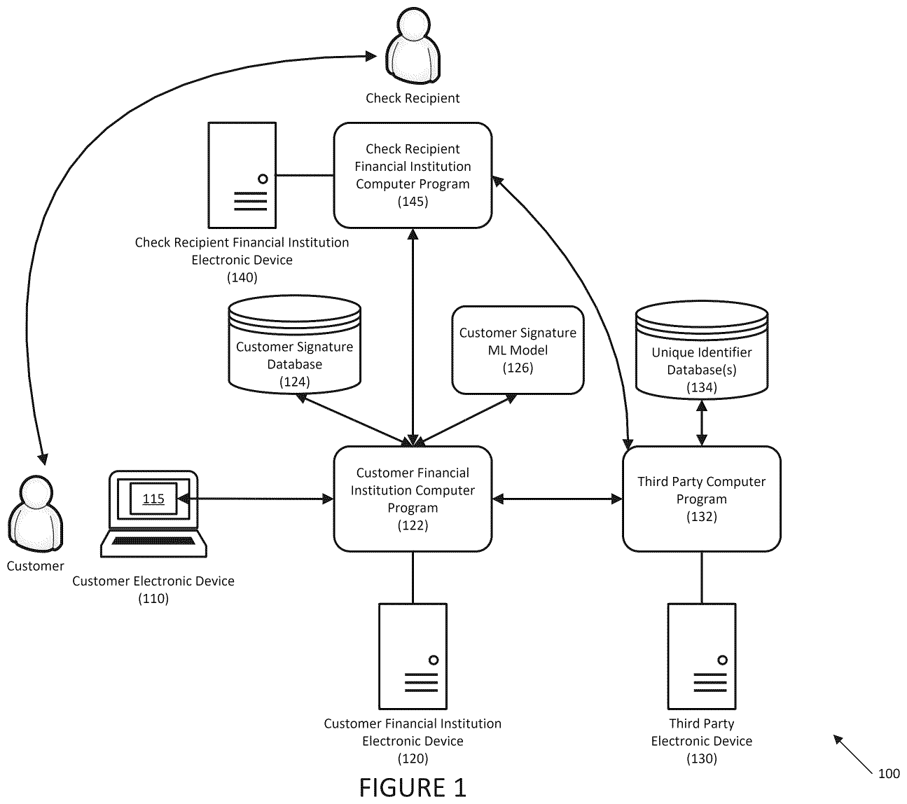

Referring to FIG. 1, a system for preventing check fraud is disclosed according to an embodiment. System 100 may include customer electronic device 110 that may be used by a customer. Examples of customer electronic devices 110 may include computers (e.g., workstations, desktops, laptops, notebooks, tablets, etc.), smart devices (e.g., smart phones, smart watches, etc.), Internet of Things (IOT) appliances, etc. Customer electronic device 110 may execute customer computer program 115, which may be a computer program, an application, a browser, etc. that may interface with customer financial institution computer program 122.

The customer may have a checking account with the customer financial institution. During the account opening process, the customer may provide one or more signature samples that customer financial institution computer program may use to train customer signature machine learning model 126. Customer financial institution computer program 122 may further store the signature sample(s) in customer signature database 124.

In addition, as checks that are written by the customer are presented to the customer financial institution, and/or as other documents with the customer's signature (e.g., loan applications, credit card applications, updated signature cards, etc.) are received, customer financial institution computer program may retrain customer signature machine learning model 126.

Customer financial institution computer program 122 may be executed by customer financial institution electronic device 120, which may be a server, a computer, etc. Customer financial institution computer program 122 may also interface with third party computer program 132 that may be executed by third party electronic device 130 for a third party, such as a check printer. In one embodiment, when the customer orders checks from the financial institution, customer financial institution computer program may provide the check order to third party computer program 132, along with customer information (e.g., customer name, account information, starting check number, number of checks, etc.).

For each check, third party computer program 132 may generate a unique identifier and may associate that unique identifier with the check number. The unique identifier may be any value that uniquely identifies a check. For example, the unique identifier may be a hash of one or more of the customer's account number, the customer financial institution's routing number, the check number, the customer's name and address, etc. In another embodiment, the unique identifier may be a random value generated by third party computer program 132.

In one embodiment, customer financial institution computer program 122 may generate a certificate that includes both a private key and a public key, and may provide the public key to third party computer program 132. Third party computer program 132 may encrypt the unique identifier using the public key.

When validating the check, the customer financial institution computer program 122 may decrypt the unique identifier using the private key. If it does not decrypt, indicating that the unique identifier is not encrypted using the private key, the check will be rejected.

Once the unique identifier is generated and associated with the check number, the association may be stored in unique identifier database 134.

The third party may have relationships with a plurality of financial institutions, and may store associations of unique identifiers and check numbers for customers for the plurality of financial institutions.

In one embodiment, third party computer program 132 may make unique identifier database 134 available to the financial institutions via an application programming interface (API).

The third party may then provide the unique identifier to the check, such as by printing the unique identifier on the check as an alphanumeric value, a machine-readable code (e.g., bar code, QR code, etc.), combinations thereon, etc.

A check recipient may receive a check from the customer in person, by mail, etc. and may provide the check, or an image thereof, to a check recipient financial institution. Check recipient financial institution computer program 145 that is executed by check recipient financial institution electronic device 140 may present the check to customer financial institution computer program 122, which may validate the signature on the check using customer signature ML model 126. Check recipient financial institution computer program 145 and/or customer financial institution computer program may validate the unique identifier for the check by accessing unique identifier database 134.

In one embodiment, third party computer program 132 may perform the validation for check recipient financial institution computer program 145 and/or customer financial institution computer program by verifying that the check number matches the unique identifier. [

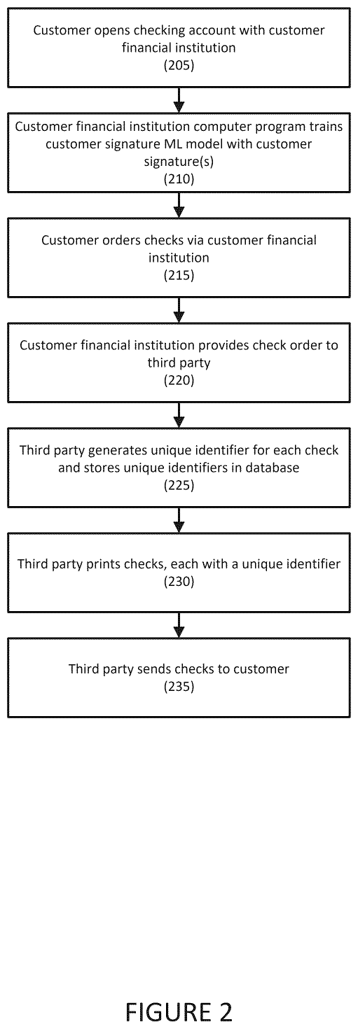

Referring to FIG. 2, a method for providing checks with unique identifiers is provided according to an embodiment.

In step 205, a customer may open a checking account with a customer financial institution. In one embodiment, as part of the account opening process, the customer may provide one or more customer signatures to the customer financial institution. The signatures may be provided on signature cards, documents, may be captured electronically, etc.

In step 210, using the customer signature(s), a customer financial institution computer program may train a customer signature machine learning model to identify the customer's signature. In one embodiment, as additional documents with the customer's signature are received (e.g., checks, loan applications, updated signature cards, updated electronic signatures, etc.), the customer financial institution computer program may re-train the customer signature ML model. This may be done periodically, as requested, or as necessary and/or desired.

In one embodiment, to train the customer signature machine learning model, the customer financial institution computer program may collect a large dataset of signatures from the customer. Preferably, the dataset includes a variety of signatures to capture natural variations.

The signature images may then be cleaned and preprocessed to standardize them for analysis. This may involve normalization, resizing, and ensuring consistent quality.

The customer financial institution computer program may extract relevant features from the signature images, such as stroke patterns, curvature, line thickness, and overall shape characteristics. The customer financial institution computer program may also use convolutional neural networks (CNNs) to automatically learn discriminative features from the signature images.

The customer financial institution computer program may then train the customer signature machine learning model using the prepared dataset. The customer signature machine learning model may be validated using a separate validation set to assess its accuracy and generalization ability.

In step 215, the customer may order checks. In one embodiment, the customer may use a check ordering process that may be provided by the customer financial institution computer program, application, or website, that may interface with a third party, such as a check printer.

In one embodiment, the customer may specify the check starting number, and may identify the number of checks to print.

In one embodiment, the customer information (e.g., name and address), routing number, account number, etc. may be pre-populated for the customer and may be provided to the third party by the customer financial institution computer program.

In step 220, the customer financial institution may provide the check order information to the third party.

In step 225, a third party computer program may generate a unique identifier for each check and may store an association between the check numbers and the unique identifiers in a database. Any suitable identifier that uniquely identifies the check may be used, including random numbers, pseudo random numbers, etc.

In one embodiment, the unique identifier may be a hash of one or more of the customer's account number, the customer financial institution's routing number, the check number, the customer's name and address, etc. In one embodiment, only the hash may be stored in the unique identifier database.

In one embodiment, the third party computer program may encrypt the unique identifiers with a public key that is provided by the customer financial institution. The public key may correspond to a private key held by the customer financial institution.

In step 230, the third party may provide the unique identifiers on the checks, and in step 235, may send the checks to the customer. For example, the check may be printed with the unique identifier as an alphanumeric code, a machine-readable code (e.g., a bar code, a QR code), etc., and may be printed on the front side and/or the back side of the check.

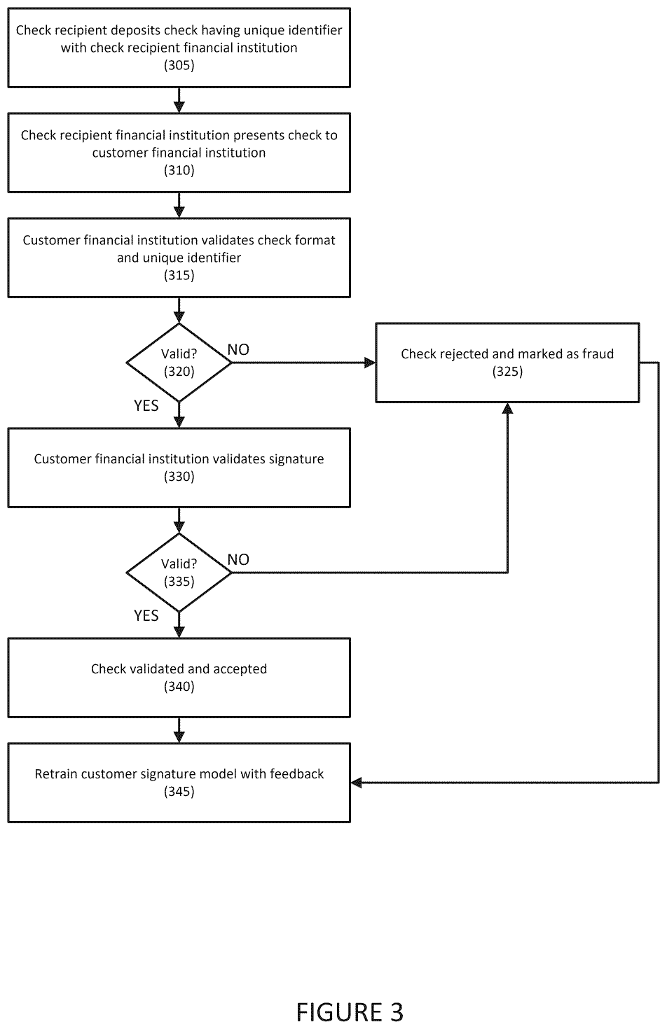

Referring to FIG. 3, a method for preventing check fraud is disclosed according to an embodiment.

In step 305, a check recipient may receive a check written by the customer, and may deposit the check having a unique identifier and a signature with the check recipient financial institution. The check recipient may deposit the paper check, an image of the check via the check recipient's mobile device, etc.

In step 310, the check recipient financial institution may present the check to the customer financial institution for payment. In one embodiment, the check recipient financial institution may present the image of the check.

In step 315, the customer financial institution may validate the check format and the unique identifier. For example, it may validate that the check has the requisite fields, that the customer name and address are correct, etc. It may also retrieve the unique identifier from the check.

For example, the unique identifier may be read from the check using optical character recognition, may be extracted from a machine readable code, etc.

The customer financial institution may attempt to decrypt the unique identifier with a private key that corresponds to a public key that the customer financial institution provided to the third party. If the unique identifier does not decrypt, the validation may fail and the check may be rejected.

The customer financial institution may validate the unique identifier by accessing a unique identifier database that may be made accessible by a third party, and may confirm that the check number and the unique identifier match the association stored in the unique identifier database.

In one embodiment, the customer financial institution may confirm that the unique identifier on the front side of the check and on the back side of the check match before validating the unique identifier.

In another embodiment, the customer financial institution may provide the unique identifier and the check number to the third party, and the third party may validate that the check number and the unique identifier match.

In another embodiment, the customer financial institution may provide the check number to the third party, and the third party may return the unique identifier that is mapped to the check number. The customer financial institution may determine whether the unique identifier from the check matches the unique identifier returned by the third party.

In another embodiment, the customer financial institution may hash one or more of the customer's account number, the customer financial institution's routing number, the check number, the customer's name and address, etc. The same elements that were hashed by the third party should be used. The customer financial institution may then verify that the hash is present in the unique identifier database, either directly or via the third party.

If, in step 320, the unique identifier is not valid, in step 325, the customer financial institution may identify the check as fraudulent and may reject payment.

If the unique identifier is valid, in step 330, the customer financial institution may validate the customer's signature using the machine learning model. For example, the customer financial institution may extract the image of the signature from the check, and may use the customer signature ML model to predict whether the signature on the check is that of the customer.

If, in step 335, the signature is predicted to be valid, in step 340, the customer financial institution may accept the check for processing.

If, in step 335, the signature is predicted to be invalid, in step 325, the check may be rejected. In one embodiment, the check may be manually reviewed.

In step 345, the customer financial institution may receive feedback, and may retrain the customer signature ML model based on the feedback. For example, if a check is rejected due to the signature, and the customer confirms that the signature is correct, the customer signature ML model may be retained with the signature. Similarly, if a check is accepted and the customer identifies the signature as being fraudulent, the customer signature ML model may be retained with the fraudulent signature.

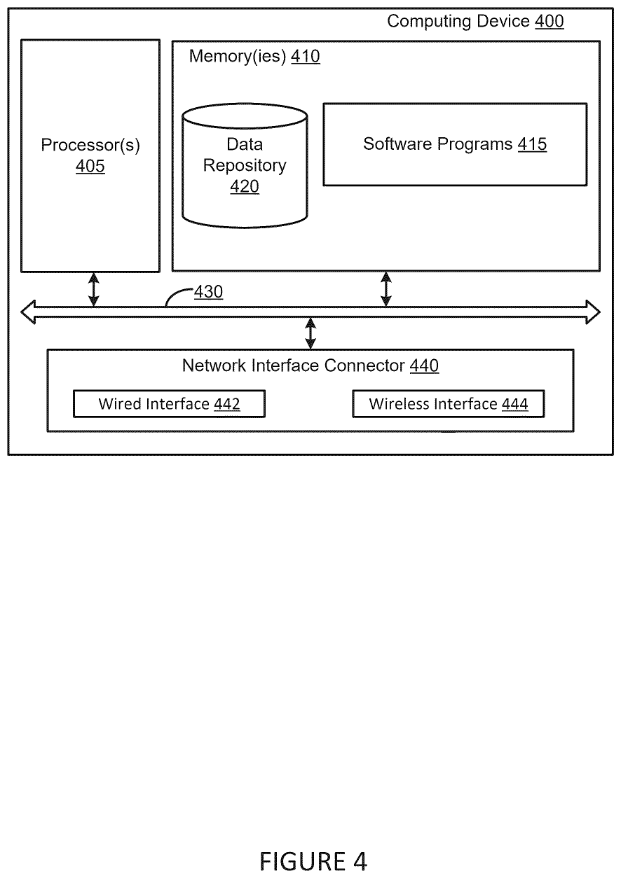

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method, comprising:
receiving, by a computer program, an image of a check presented for deposit comprising a unique identifier that is embedded in a bar code or a quick response code that is printed on the check, wherein the unique identifier uniquely identifies the check and is encrypted with a public key for an issuing financial institution;
decrypting, by the computer program, the unique identifier using a private key corresponding to the public key;
extracting, by the computer program, a check image check number from the image of the check;
accessing by the computer program, a database comprising an association between unique identifiers and check numbers;
confirming that the unique identifier for the check and the check image check number for the check are mapped together in the database; and
accepting, by the computer program, the image of the check for payment in response to the unique identifier for the check and the check number for the check being associated in the database

2. The method of claim 1, wherein the unique identifier comprises a hash of one or more of an account number, a routing number, a check number, a customer name, and a customer address.

3. The method of claim 2, wherein the step of validating, by the computer program, the unique identifier by accessing unique identifier database comprises:
extracting, by the computer program and from the image of the check, the unique identifier, a check image account number, a check image routing number, a check image check number, a check image customer name, and a check image customer address;
hashing, by the computer program, one or more of the check image account number, the check image routing number, the check image check number, the check image customer name, and the check image customer address; and
identifying, by the computer program, the hash of the one or more of the check image account number, the check image routing number, the check image check number, the check image customer name, and the check image customer address in the unique identifier database.

4. The method of claim 1, wherein the unique identifier comprises a random alphanumeric value, wherein the unique identifier is mapped to a check number, and wherein the step of validating, by the computer program, the unique identifier by accessing unique identifier database comprises:
extracting, by the computer program and from the image of the check, the unique identifier and a check image check number; and
determining, by the computer program, that the unique identifier is mapped to the check image check number in the unique identifier database comprising a plurality of valid unique identifiers.

5. (canceled)

6. The method of claim 1, wherein the image of the check further comprises a customer signature, and further comprising:
receiving, by the computer program, a dataset comprising a plurality of signature images for a customer;
training, by the computer program, a customer signature machine learning model with the dataset;
verifying, by the computer program and using the customer signature machine learning model, that the customer signature is valid; and
accepting, by the computer program, the image of the check for payment in response to the customer signature being valid and the unique identifier being valid.

7. The method of claim 6, wherein the customer signature machine learning model is trained using convolutional neural networks to automatically learn discriminative features from the plurality of signature images.

8. The method of claim 1, wherein the unique identifier is embedded within a machine-readable code on the check.

9. The method of claim 1, wherein the unique identifier is provided on both a front side and on a back side of the check.

10. A method, comprising:
maintaining, by a computer program, a unique identifier database comprising a plurality of check numbers, each of the plurality of check numbers mapped to a unique identifier that uniquely identifies a check, wherein the unique identifier is embedded in a bar code or a quick response code that is printed on the check;
receiving, by a computer program and from a financial institution computer program for a financial institution, a check number and a unique identifier for a check that is being presented for payment to the financial institution;
verifying, by the computer program, that the check number is mapped to the unique identifier in the unique identifier database; and
notifying, by the computer program, the financial institution computer program of the verification.

11. The method of claim 10, wherein the unique identifier comprises a hash of one or more of an account number, a routing number, a check number, a customer name, and a customer address.

12. The method of claim 10, wherein the unique identifier comprises a random alphanumeric value.

13. The method of claim 10, wherein the computer program maintains one or more unique identifier databases for a plurality of financial institutions.

14. The method of claim 10, wherein the step of maintaining, by the computer program, the unique identifier database comprises:
receiving, by the computer program, an order for a plurality of checks comprising a plurality of check numbers;
generating, by the computer program, a unique identifier for each of the plurality of check numbers in the order; and
mapping, by the computer program, the unique identifiers to the check numbers in the order and storing the mapping in the unique identifier database.

15. The method of claim 14, further comprising:
causing, by the computer program, each of the plurality of checks in the order to be printed with the unique identifier mapped to the check.

16. A system, comprising:
a financial institution computer program for a financial institution; and
a third party computer program for a third party;
wherein:
the third party computer program maintains a unique identifier database comprising a plurality of check numbers, each of the plurality of check numbers mapped to a unique identifier that uniquely identifies a check, wherein the unique identifier is embedded in a bar code or a quick response code that is printed on the check;
the financial institution computer program receives an image of a check presented for deposit comprising a unique identifier that is provided on the check, wherein the unique identifier uniquely identifies the check;
the financial institution extracts, from the image of the check, a check number and the unique identifier;
the financial institution computer program provides the unique identifier and the check number to the third party computer program;
the third party computer program verifies that the check number is mapped to the unique identifier in the unique identifier database; and
the third party computer program notifies the financial institution computer program of the verification.

17. The system of claim 16, wherein the unique identifier comprises a hash of one or more of an account number, a routing number, a check number, a customer name, and a customer address.

18. The system of claim 16, wherein the unique identifier comprises a random alphanumeric value, wherein the unique identifier is mapped to the check number.

19. The system of claim 16, wherein the image of the check further comprises a customer signature, wherein:
the financial institution computer program receives a dataset comprising a plurality of signature images for a customer;
the financial institution computer program trains a customer signature machine learning model with the dataset;
the financial institution computer program verifies, using the customer signature machine learning model, that the customer signature is valid; and
the financial institution computer program accepts the image of the check for payment in response to the customer signature being valid and the unique identifier being valid.

20. The system of claim 19, wherein the customer signature machine learning model is trained using convolutional neural networks to automatically learn discriminative features from the plurality of signature images.
